(19) United States
(12) Patent Application Publication
(10) Pub. No.: US 2021/0383947 A1
(43) Pub. Date: Dec. 9, 2021

(54) WINDING WIRE HAVING INSULATION LAYER WRAPPING AROUND MULTIPLE WIRES

(71) Applicant: Delta Electronics (Jiangsu) Ltd., Jiangsu Province (CN)

(72) Inventors: Xiaoxia YUAN, Jiangsu Province (CN); Ming Hsien PENG, Jiangsu Province (CN); Shaodong ZHANG, Jiangsu Province (CN)

(21) Appl. No.: 17/445,728

(22) Filed: Aug. 23, 2021

Related U.S. Application Data
(63) Continuation-in-part of application No. 15/908,826, filed on Mar. 1, 2018.

(30) Foreign Application Priority Data
Jun. 23, 2017 (CN) 201710487958.1

(51) Int. Cl. H01B 7/02; H01F 27/28

(52) U.S. Cl. CPC H01B 7/0258; H01F 27/2823; H01B 7/0216

(57) ABSTRACT

The present application discloses a winding wire, comprising: a plurality of wires each comprising a core and a coating covering the core; and an insulation layer wrapping around the plurality of wires, wherein the plurality of wires are twisted spirally at least thirty-three times in a length of one meter, and wherein the plurality of wires twisted spirally are disposed in an X-axis direction of the insulating layer, and the insulating layer continuously wraps around the plurality of wires twisted spirally along a Y-axis direction perpendicular to the X-axis direction until a number of layers covering the plurality of wires twisted spirally is at least three.

### CROSS-REFERENCE TO RELATED APPLICATIONS

This non-provisional application is a Continuation-In-Part application of patent application Ser. No. 15/908,826 filed in the U.S. on Mar. 1, 2018, which claims priority under 35 U.S.C. § 119(a) on Patent Application No. 201710487958.1 filed in P.R. China on Jun. 23, 2017, the entire contents of which are hereby incorporated by reference.

Some references, if any, which may include patents, patent applications and various publications, may be cited and discussed in the description of this application. The citation and/or discussion of such references, if any, is provided merely to clarify the description of the present application and is not an admission that any such reference is “prior art” to the application described herein. All references listed, cited and/or discussed in this specification are incorporated herein by reference in their entireties and to the same extent as if each reference was individually incorporated by reference.

### TECHNICAL FIELD

The present application relates to a winding wire having an insulation layer wrapping around multiple wires.

### BACKGROUND ART

The winding wire used in the switching mode power supply transformer is required to withstand an extremely high voltage. In order to meet the safety requirement and the insulation requirement, a three-layer insulated Kara line is used as the winding wire for most of the existing switching mode power supply transformers, which increases the material cost of the winding wire. On the other hand, the three-layer insulated Kara line is so hard that, when they are processed into windings, the resultant transformer will occupy too large space, which decreases the power density of the transformer. In summary, if the three-layer insulated Kara line is used as winding wire, the overall competitiveness of the product will be reduced, so it is urgent to develop a winding wire to overcome the above-mentioned defects.

### DISCLOSURE OF THE APPLICATION

One aspect of the disclosure is to provide a winding wire comprising: a plurality of wires each comprising a core and a coating covering the core; and an insulation layer wrapping around the plurality of wires, wherein the plurality of wires are twisted spirally at least thirty-three times in a length of one meter, and wherein the plurality of wires twisted spirally are disposed in an X-axis direction of the insulating layer, and the insulating layer continuously wraps around the plurality of wires twisted spirally along a Y-axis direction perpendicular to the X-axis direction until a number of layers covering the plurality of wires twisted spirally is at least three.

Another aspect of the disclosure is to provide a winding of a magnetic element, comprising the winding wire as described above.

In the disclosure, each of the wires and the insulation layer constituting the winding wire has a low material cost, and the winding wire may have a high breakdown voltage and may withstand a high arcing current for a long period. Therefore, the winding wire that can be applied to the power supply transformer operating under high voltage is manufactured with a low cost.

### BRIEF DESCRIPTION OF THE DRAWINGS

FIG. 1 is a top view of the structure of the winding wire provided by an embodiment of the present application;

FIG. 2 is a side view of the structure of the winding wire provided by an embodiment of the present application;

FIG. 3 is a top view of the structure of the winding wire provided by another embodiment of the present application;

FIG. 4 is a side view of the structure of the winding wire provided by another embodiment of the present application;

FIG. 5 is a flow chart of a method for producing the winding wire in FIG. 1;

FIG. 6 is a step-by-step flow chart of step S12 in FIG. 5;

FIG. 7 is a flow chart of a method for producing the winding wire in FIG. 3;

FIG. 8 is a top view of the structure of the winding wire provided by yet another embodiment of the present application;

FIG. 9 is a sectional view of the winding wire shown in FIG. 1;

FIG. 10 is a sectional view of the winding wire shown in FIG. 8;

FIG. 11 is a sectional view of a single wire of the winding wire;

FIG. 12 is a side view of a plurality of wires twisted spirally;

FIG. 13 is a side view of a winding wire having an insulation layer wrapping around the plurality of wires twisted spirally shown in FIG. 12;

FIG. 14 is a sectional view of the winding wire shown in FIG. 13.

### EMBODIMENTS

Reference will be made in detail to the accompanying drawings and embodiments of the present application. The embodiments were carried out on the premise of the technical solutions of the present application, and methods and operation processes are disclosed, but the protection scope of the present application is not limited to the following embodiments.

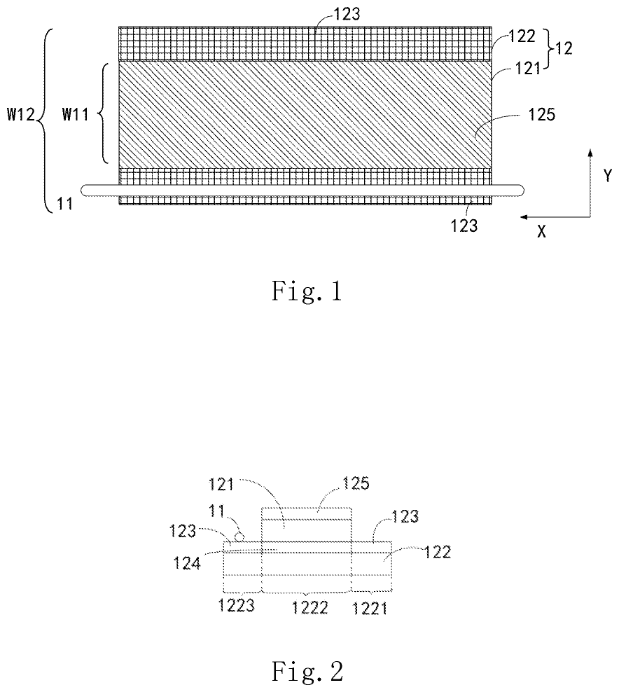

As shown in FIGS. 1-2, the winding wire of the present application comprises a wire 11 and an insulation structure 12, the wire 11 can be a substantially insulated solid wire or a substantially insulated strand wire, etc., the insulation structure 12 wraps around the wire 11. The insulation structure 12 comprises a first insulating layer 121 and a second insulating layer 122. The first insulating layer 121 has a first width W11, and the second insulating layer 122 has a second width W12, wherein the first width W11 is less than the second width W12. The second insulating layer 122 has an X-axis direction and a Y-axis direction perpendicular to the X-axis direction, and the first insulating layer 121 is disposed on the second insulating layer 122 in a direction parallel to the X-axis, and the wire 11 is disposed, in a direction parallel to the X-axis, on the portion of the second insulating layer 122 that is not covered by the first insulating layer 121. The first insulating layer 121 and the second insulating layer 122 wrap around the wire 11 in the Y-axis direction. For example, the number of insulating layers of the winding wire is at least three to meet the safety requirements, the number of insulating layers of the winding wire is at least three layers to meet the safety requirements. The number of insulating layers of the winding wire can be controlled by the first width W11 and/or the second width 12 and the location of the first insulating layer 121 on the second insulating layer 122. This processing method is simple, and the cost is also lower than the three-layer insulated Kara line.

Further, after the first insulating layer 121 bonded to the second insulating layer 122, the second insulating layer 122 is sequentially divided into a first fixed part 1221, an overlapping part 1222 and a second fixed part 1223 in the Y-axis direction, and the wire 11 is disposed on the second fixed part 1223 in the X-axis direction. The width of the first fixed part 1221 and/or the second fixed part 1223 may be greater than or equal to the perimeter of the wire 11, and the width of the overlapping part 1222 also may be greater than or equal to the perimeter of the wire 11. Specifically, the widths of the first fixed part 1221, the second fixed part 1223, and the overlapping part 1222 can be equal to the perimeter of the wire 11, and then the number of the insulating layers of the winding wire is exactly three, which is beneficial to further saving materials and reducing costs, and is easy to realize automatic processing.

Furthermore, the insulation structure 12 further comprises a first adhesive layer 123 and a second adhesive layer 124; the first adhesive layer 123 is disposed on the first fixed portion 1221 and/or the second fixed part 1223, the wire 11 is disposed on the first adhesive layer 123, and the first adhesive layer 123 is used to fix the wire more securely on the second insulating layer; the second adhesive layer 124 is disposed between the overlapping part 1222 and the first insulating layer 121 for bonding the first insulating layer 121 and the second insulating layer 122; Wrapping around the wire 11 begins from the second fixed part 1223 provided with the wire 11 until bonded to the first fixed portion 1221. As shown in FIG. 2, the thicknesses of the first adhesive layer 123 and the second adhesive layer 124 can be controlled to the same.

In other embodiments, the wire 11 may also be disposed on the first fixed part 1221 in a direction parallel to the X-axis, and wrapping around the wire 11 begins from the first fixed part 1221 provided with the wire 11 until bonded to the second fixed part 1223.

The winding wire of the present application can be carried out in such a manner that the wire and the first insulating layer are contact directly with each other, so that it makes the insulation structure winding the wire more easily and smoothly to ensure that the processed wire surface is flat and compact, but the application is not limited to this.

Further, the insulation structure 12 comprises a third adhesive layer 125 disposed on the first insulating layer 121. Compared with the foregoing manner in which the wire and the first insulating layer are contact directly with each other, this manner allows the wire to be better fixed during winding process.

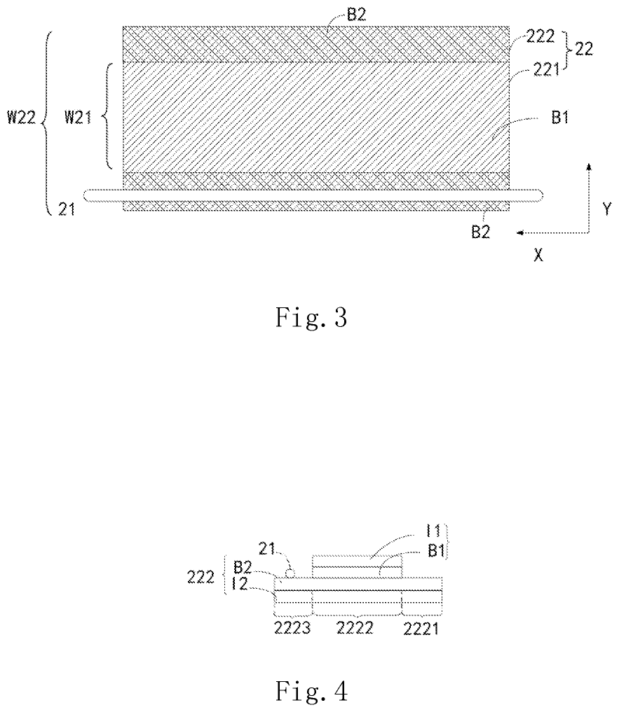

Referring to FIGS. 3-4, FIG. 3 is a top view of the structure of a second embodiment of the winding wire of the present application, and FIG. 4 is a side view of FIG. 3. The winding wire of the present application comprises a wire 21 and an insulation structure 22, the insulation structure 22 wraps around the wire 21, the wire 21 can be a substantially insulated solid wire or a substantially insulated strand wire, etc. The insulation structure 22 comprises a first insulating tape 221 and a second insulating tape 222. The first insulating tape 221 has a first width W21; the second insulating tape 222 has a second width W22, and the second insulating tape 222 has an X-axis direction and a Y-axis direction perpendicular to the X-axis direction. The first insulating tape 221 is bonded to the second insulating tape 222 in a direction parallel to the X-axis, and the first width W21 is less than the second width W22. The wire 21 is disposed, in a direction parallel to the X-axis, on the portion of the second insulating tape 222 that is not covered by the first insulating tape 221, and the first insulating tape 221 and the second insulating tape 222 wrap around the wire 21 in the Y-axis direction. The number of insulating layers of the winding wire is at least three to meet the safety requirements.

The first insulating tape 221 comprises a first backing layer B1 and a first insulating substrate layer Il which are disposed opposite to each other, and the second insulating tape 222 comprises a second backing layer B2 and a second insulating substrate layer 12 which are disposed opposite to each other. The first backing layer B1 is bonded to the second backing layer B2. The second insulating substrate layer 12 of the second insulating tape 222 is divided into a first fixed part 2221, an overlapping part 2222 and a second fixed part 2223 sequentially in the Y-axis direction. In other words, the first insulating substrate layer Il and the second insulating substrate layer 12 are the first insulating layer and the second insulating layer, respectively.

The wire 21 is disposed on the second fixed part 2223 in a direction parallel to the X-axis, and since there is the second backing layer B2 between the second fixed part 2223 and the wire, the wire can be fixed to the second insulating layer more securely before winding; When wrapping around the wire 21, the part of the first insulating tape that is in contact with the winding wire is the insulating substrate layer I1. Since the contact surface is a smooth, flat surface, the wire can be wound more easily and smoothly to ensure that the processed wire surface is flat and compact. Moreover, since the first fixed part 2221 also has the backing layer B2 thereon, it can be adhered to the second insulating substrate layer 12 more conveniently to finally complete the winding. In addition, the texture of the insulating tapes is relatively soft, so, when the winding wire is used for producing the windings of a transformer or another magnetic element, gaps between the winding wires can be reduced compared with the three-layer insulated Kara line, thereby further reducing the volume of the magnetic element and further enhancing the power density. Besides, the wire 21 can also be disposed on the first fixed part 2221 in a direction parallel to the X-axis, and wrapping around the wire 21 begins from the first fixed part 2221 provided with the wire 21 until bonded to the second fixed part 2223.

In another embodiment of the present application, the first insulating substrate layer Il is bonded to the second backing layer B2, and the insulating substrate layer 12 of the second insulating tape 222 is divided into a first fixed part 2221, an overlapping part 2222, and a second fixed part 2223 sequentially.

The width of the first fixed part 2221 and/or the second fixed part 2223 may be greater than or equal to the perimeter of the wire 21, and the width of the overlapping part 2222 may also be greater than or equal to the perimeter of the wire 121. Specifically, the widths of the first fixed part 2221, the second fixed part 2223, and the overlapping part 2222 can be equal to the perimeter of the wire 21, and then the number of the insulating layers of the winding wire is exactly three, which is advantageous for the further saving of materials and costs, and which facilitates automatic processing.

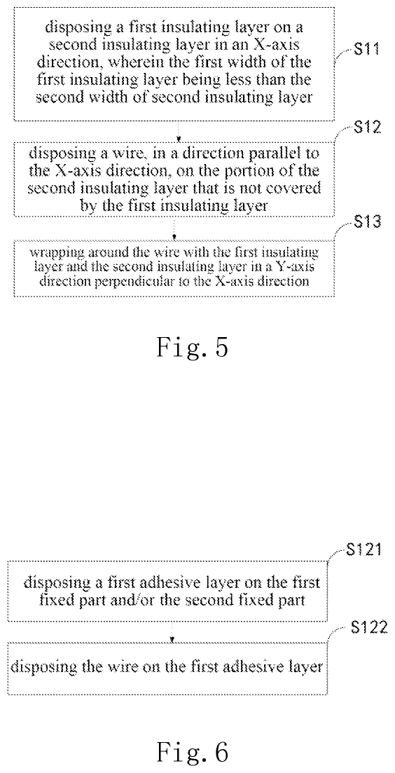

Referring to FIGS. 5-6, FIG. 5 is a flow chart of a method for producing the winding wire in FIG. 1, and FIG. 6 is a step-by-step flow chart of step S12 in FIG. 5. As shown in FIGS. 5-6, the method for producing a winding wire according to the present application comprises:

Step S11: disposing a first insulating layer on a second insulating layer in an X-axis direction, wherein the first width of the first insulating layer being less than the second width of second insulating layer. In an embodiment of the present application, after the first insulating layer is disposed on the second insulating layer, the second insulating layer is divided into a first fixed part, an overlapping part and a second fixed part sequentially in the Y-axis direction. The width of the first fixed part and/or the second fixed part may be greater than or equal to the perimeter of the wire, and the width of the overlapping part may be greater than or equal to the perimeter of the wire. Specifically, the widths of the first fixed part, the second fixed part and the overlapping part can be equal to the perimeter of the wire, and then the number of the insulating layers of the winding wire is exactly three, which is advantageous for the further saving of materials and costs, and which facilitates automatic processing. In another embodiment of the present application, after the first insulating layer disposed on the second insulating layer, the second insulating layer is divided into a first fixed portion and an overlapping portion in the Y-axis direction, but the present application is not limited to this.

Step S12: disposing a wire, in a direction parallel to the X-axis, on the portion of the second insulating layer that is not covered by the first insulating layer. In an embodiment of the present application, after the first insulating layer disposed on the second insulating layer, the second insulating layer is divided into a first fixed part, an overlapping part and a second fixed part sequentially in the Y-axis direction. The wire is disposed on the first fixed part or the second fixed part. The wire can be a substantially insulated solid wire or a substantially insulated strand wire, etc.

Step S13: wrapping around the wire with the first insulating layer and the second insulating layer in a Y-axis direction perpendicular to the X-axis direction, wherein wrapping around the wire begins from the first fixed part provided with the wire to the second fixed part; or wrapping around the wire begins from the second fixed part provided with the wire to the first fixed part.

Further, Step S12 further comprises:

Step S121: disposing a first adhesive layer on the first fixed part and/or the second fixed part; and

Step S122: disposing the wire on the first adhesive layer.

Further, disposing a second adhesive layer between the overlapping part and the first insulating layer in Step S11, and/or further disposing a third adhesive layer on the first insulating layer in Step S11.

Furthermore, the first insulating layer and the second insulating layer wrap around the wire until the number of insulating layers of the winding wire is at least three.

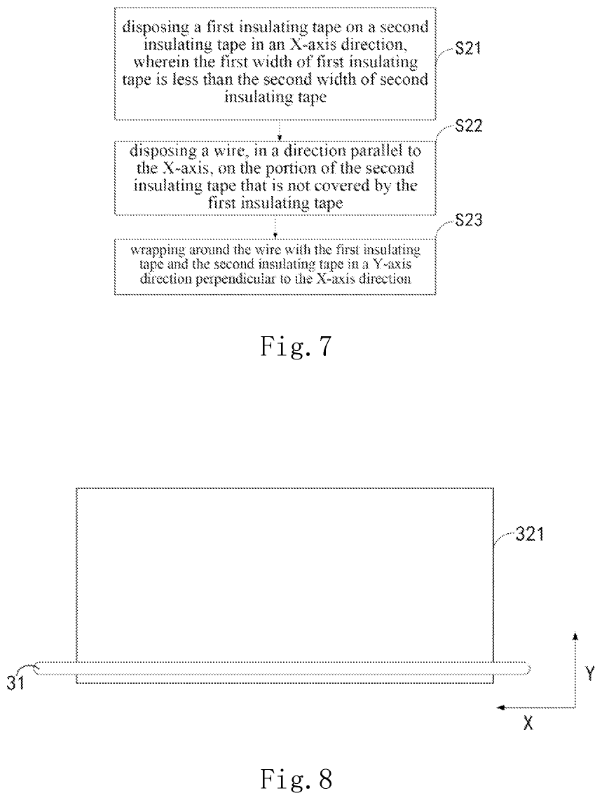

Referring to FIG. 7, which is a flow chart of a method for producing the winding wire in FIG. 3. As shown in FIG. 7, the method for producing a winding wire according to the present application comprises:

Step S21: disposing a first insulating tape on a second insulating tape in an X-axis direction, wherein the first width of first insulating tape is less than the second width of second insulating tape;

Step S22: disposing a wire, in a direction parallel to the X-axis, on the portion of the second insulating tape that is not covered by the first insulating tape, the wire being a substantially insulated solid wire or a substantially insulated strand wire; and

Step S23: wrapping around the wire with the first insulating tape and the second insulating tape in a Y-axis direction perpendicular to the X-axis direction.

Furthermore, in Step 21, the first insulating tape comprises a first backing layer and a first insulating substrate layer which are disposed opposite to each other, and the second insulating tape comprises a second backing layer and a second insulating substrate layer which are disposed opposite to each other; in step 21, the first backing layer is bonded to the second backing layer, i.e., the first insulating tape is bonded to the second insulating tape to divide the second insulating substrate layer 12 of the second insulating tape 222 into a first fixed part 2221, an overlapping part 2222 and a second fixed part 2223 sequentially in the Y-axis direction. In other words, the first insulating substrate layer and the second insulating substrate layer are the first insulating layer and the second insulating layer, respectively.

Moreover, in Step S22, the wire is disposed on the second fixed part in a direction parallel to the X-axis. Since there is a second backing layer between the second fixed part and the wire, the wire can be fixed to the second insulating layer more securely before winding; In Step S23, the first insulating tape and the second insulating tape wrapping around the wire begins from the second fixed part provided with the wire to the first fixed part. The contact part of the first insulating tape with the winding wire is an insulating substrate layer which is a smooth, flat surface, so it is easier to wind the wire smoothly to ensure that the processed wire surface is flat and compact. Moreover, since the first fixed part also has the backing layer thereon, it can be adhered to the second insulating substrate layer more conveniently to complete the winding and obtain a winding wire comprising insulating layers.

In other embodiments, the wire can also be disposed on the first fixed part in a direction parallel to the X-axis, and wrapping around the wire begins from the first fixed part provided with the wire until bonded to the second fixed part.

According to other aspects of the present application, the first insulating substrate layer is bonded to the second backing layer to divide the insulating substrate layer 12 of the second insulating tape into a first fixed part, an overlapping part and a second fixed part sequentially.

Further, the width of the first fixed part 2221 and/or the second fixed part 2223 can be greater than or equal to the perimeter of the wire 21, and the width of the overlapping part 2222 can be greater than or equal to the perimeter of the wire 21. When the widths of the first fixed part 2221, the second fixed part 2223 and the overlapping part 2222 are all equal to the perimeter of the wire 21, the number of the insulating layers of the winding wire is exactly three, which is advantageous for the further saving of materials and costs, and which facilitates automatic processing.

Referring to FIG. 8, the winding wire of the present application comprises a wire 31 and a first insulating layer 321, wherein the wire 31 is a substantially insulated solid wire or a substantially insulated strand wire. The first insulating layer 321 has an X-axis direction and a Y-axis direction perpendicular to the X-axis direction. The wire 31 is disposed on the first insulating layer 321 in the X-axis direction, and the first insulating layer 321 wraps around the wire 31 in the Y-axis direction.

By setting the width of the first insulating layer 321, the number of insulating layers of the winding wire can be at least three after the first insulating layer 321 wraps around the wire 31. For example, the first insulating layer 321 is the insulating substrate layer of an insulating tape, and the wire 31 is disposed on the first insulating layer 321 in a direction parallel to the X-axis, wherein the backing layer of insulating tape is between the wire 31 and the first insulating layer 321.

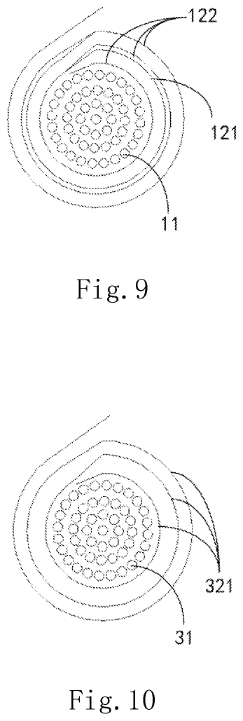

Referring to FIGS. 1 and 9, the first insulating layer 121 and the second insulating layer 122 wrap around the wire 11 until the number of insulating layers of the winding wire is at least three.

Referring to FIGS. 8 and 10, the first insulating layer 321 wraps around the wire 31 until the number of insulating layers of the winding wire is at least three.

The present application further discloses a winding of a magnetic element, comprising the winding wire shown in FIG. 1 or FIG. 3 or FIG. 8 as described above, that is, the winding is produced from said winding wire.

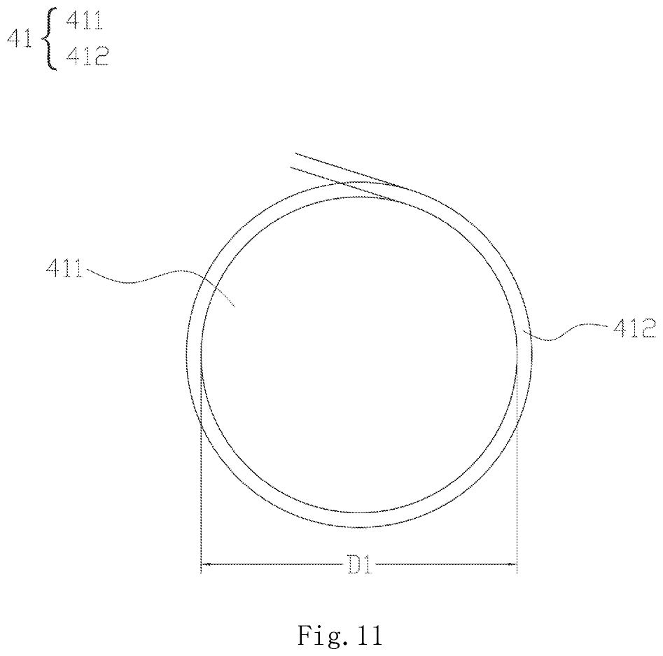

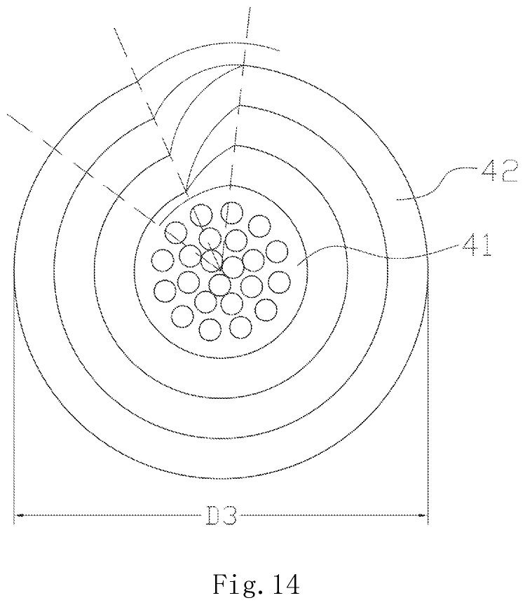

Referring to FIGS. 11 to 14, the present application further discloses a winding wire comprises a plurality of wires 41 and an insulation layer 42. Each of the plurality of wires 41 may be one of the wires 11, 21 and 31 as described above, and the insulation layer 42 may be one of the insulation structure 12, 22 and the insulation layer 321 as described above.

Each of the plurality of wires 41 comprises a core 411 and a coating 412 covering the core 411 as shown in FIG. 11. The core 411 may be made of copper material. The core 411 has a first diameter (D1) less than or equal to 0.2 mm such that the core 411 may have an improved flexibility. The coating 412 has a thickness less than or equal to 0.1 mm, preferably from 0.02 mm to 0.03 mm The coating 412 has an elongation greater than or equal to 15% such that the wire 41 having the core 411 covered with the coating 412 may bend easily. Also, the coating 412 has a withstanding voltage greater than or equal to 1 kV to improve the insulation property of the wire 41.

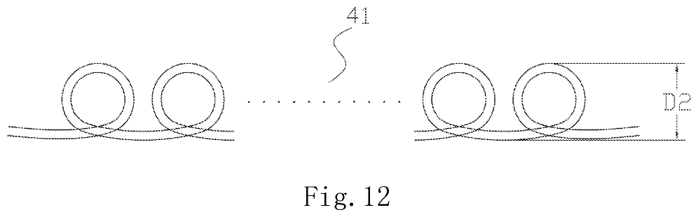

The plurality of wires 41 are arranged close to each other and are twisted spirally at least thirty-three (33) times in a length of one meter as shown FIG. 12. In other words, the plurality of wires 41 are gathered together and are twisted 360 degrees in a clockwise direction or an anti-clockwise direction at least thirty-three times in a length of one meter. Specifically, the plurality of wires 41 may be twisted spirally from thirty-three (33) times to eighty-five (85) times in a length of one meter. Wherein, FIG. 12 is only for schematic, which is not the actual winding shape.

The plurality of wires 41 are forced to be closer to each other after being twisted spirally, and a gap between adjacent wires 41 is less than 0.1 mm. The plurality of wires 41 twisted spirally may form a circle having a second diameter (D2) in a sectional direction, where D2≤C*√N*D1, and C is constant related to the number of times twisted, N is a number of the plurality of wires 41. In some embodiments, for example, when the plurality of wires 41 are twisted spirally thirty-three times in a length of one meter, C can be 1.115. Wherein, the value of C is inversely related to the number of times twisted of the stranded wire.

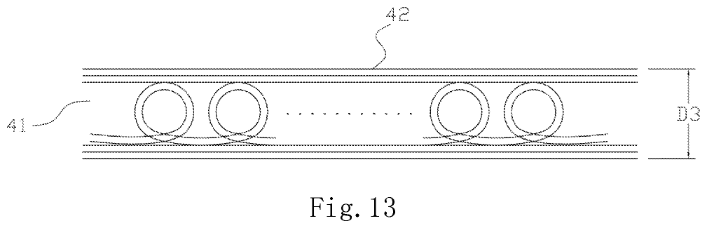

After the wires 41 are twisted spirally, the wires 41 are wrapped by the insulating layer 42 as shown in FIG. 13. The insulating layer 42 continuously wraps around the wires 41 until a number of layers covering the wires 41 is at least three.

The insulating layer 42 wraps around the wires 41 tightly such that each of the wires 41 located on a circumference of the circle is spaced apart from the insulation layer 42 by a gap less than 0.1 mm Further, the layers covering the wires 41 are stacked on each other smoothly and closely without wrinkle or space between adjacent layers. The winding wire having the plurality of wires 41 wrapped by the insulation layer 42 may have a third diameter (D3) less than a sum of the second diameter (D2) and a total thickness of the layers covering the plurality of wires 41. In one embodiment, a thickness of the insulation layer 42 is less than or equal to 0.1 mm. The total thickness of the layers covering the plurality of wires 41 may be obtained by multiplying the thickness of the insulation layer 42 by the number of layers covering the plurality of wires 41.

The winding wire having the above configuration may meet the safe requirement under IEC 65960 and IEC 60065. Particularly, the winding wire may have a breakdown voltage greater than or equal to 5 KV. More particularly, the winding wire is capable of withstanding an arcing current of 7.7 mA for 60 seconds.

In view of the above, the winding wire of the present application can be applied to a switching mode power supply transformer operating under high voltage, while meeting the safe requirement and the insulating requirement. The winding wire of the present application can be manufactured by using materials having low cost, and the power density of magnetic elements is increased while reinforcing insulation.

Finally, the above embodiments are merely meant to illustrate rather than limit the technical solutions described in the present application; moreover, although the present application is described in detail with reference to the above embodiments in this specification, the ordinary persons skilled in the art should understand that modifications or equivalent substitutions can still be made to part or all of the present application; thus, all the technical solutions not departing from the spirit and scope of the present application and the improvements thereof should be covered by the protection scope of the appended claims of the present application.

What is claimed is:

1. A winding wire, comprising:
a plurality of wires each comprising a core and a coating covering the core; and
an insulation layer wrapping around the plurality of wires,
wherein the plurality of wires are twisted spirally at least thirty-three times in a length of one meter, and
wherein the plurality of wires twisted spirally are disposed in an X-axis direction of the insulating layer, and the insulating layer continuously wraps around the plurality of wires twisted spirally along a Y-axis direction perpendicular to the X-axis direction until a number of layers covering the plurality of wires twisted spirally is at least three.

2. The winding wire according to claim 1, wherein the core has a first diameter (D1) less than or equal to 0.2 mm

3. The winding wire according to claim 1, wherein an elongation of the coating is greater than or equal to 15%,
a thickness of the coating is less than or equal to 0.1 mm, and
a withstanding voltage of the coating is greater than or equal to 1 kV.

4. The winding wire according to claim 2, wherein the plurality of wires are twisted spirally to form a circle having a second diameter (D2) in a sectional direction,
D2≤C*√N*D1, and C is constant related to the number of times twisted, N is a number of the plurality of wires.

5. The winding wire according to claim 4, wherein the value of C is inversely related to the number of times twisted of the plurality of wire.

6. The winding wire according to claim 4, wherein C is equal to 1.115 when the plurality of wires are twisted spirally thirty-three times in a length of one meter.

7. The winding wire according to claim 4, wherein a gap between adjacent wires among the plurality of wires twisted spirally is less than 0.1 mm

8. The winding wire according to claim 4, wherein the winding wire has a third diameter (D3) less than a sum of the second diameter (D2) and a total thickness of the layers covering the plurality of wires twisted spirally.

9. The winding wire according to claim 8, wherein a thickness of the insulation layer is less than or equal to 0.1 mm

10. The winding wire according to claim 8, wherein each of the wires located on a circumference of the circle is spaced apart from the insulation layer by a gap less than 0.1 mm

11. The winding wire according to claim 1, wherein the winding wire has a breakdown voltage greater than or equal to 5 KV.

12. The winding wire according to claim 1, wherein the winding wire is configured to withstand an arcing current of 7.7 mA for 60 seconds.

13. A winding of a magnetic element, comprising the winding wire according to claim 1.
